(19) United States
(12) Patent Application Publication
(10) Pub. No.: US 2008/0066443 A1
(43) Pub. Date: Mar. 20, 2008

(54) GAS TURBINE PLANT FOR A WORKING MEDIUM IN THE FORM OF A CARBON DIOXIDE/WATER MIXTURE

(75) Inventors: Hans Ulrich Frutschi, Riniken (CH); Timothy Griffin, Ennetbaden (CH); Roland Span, Paderborn-Sande (DE); Dieter Winkler, Lauchringen (DE)

Correspondence Address: STEPTOE & JOHNSON LLP, 1330 CONNECTICUT AVENUE, N.W., WASHINGTON, DC, 20036, US

(73) Assignee: ALSTOM Technology Ltd

(21) Appl. No.: 11/845,182

(22) Filed: Aug. 27, 2007

Related U.S. Application Data
(62) Division of application No. 10/806,225, filed on Mar. 23, 2004, now abandoned.
Application No. 10/806,225 is a continuation of application No. PCT/IB02/03912, filed on Sep. 23, 2002.

(30) Foreign Application Priority Data
Sep. 24, 2001 (CH) CH 1765/01

(51) Int. Cl. F02C 7/00

(52) U.S. Cl. 60/39.53

(57) ABSTRACT

A gas turbine plant with a compressor, a combustion chamber, a turbine and at least one heat sink is operated with a working medium in the form of a carbon dioxide/water mixture. A hydrocarbon reacts as fuel with oxygen in the combustion chamber, and the excess carbon dioxide and water thereby occurring is tapped from the circuit. The compressor and the turbine have in each case a rotor with moving blades and a casing with flow ducts and with guide blade cascades. In the compressor and/or the turbine, matching to the expansion behavior of the working medium, which is different from that of air, is brought about by modifications of the flow ducts, of the moving blades and/or of the guide blade cascades.

### CROSS-REFERENCE TO RELATED APPLICATIONS

This application is a divisional of prior U.S. patent application Ser. No. 10/806,225 filed Mar. 23, 2004, which is a continuation of the U.S. National Stage designation of co-pending International Patent Application PCT/IB02/03912 filed Sep. 23, 2002, and the entire contents of these prior applications are expressly incorporated herein by reference thereto.

### FIELD OF THE INVENTION

The present invention relates to the field of technology of gas turbines. It refers to a gas turbine plant for a working medium in the form of a carbon dioxide/water mixture.

### BACKGROUND OF THE INVENTION

The prior art discloses gas turbine plants that operate in a circuit with a working medium in the form of a carbon dioxide/water mixture and are distinguished in that they allow the combustion of hydrocarbon-containing fuels, without carbon dioxide being discharged into the atmosphere. Such a gas turbine plant is described, for example, in the publication U.S. Pat. No. 5,247,791.

FIG. 1 illustrates a block diagram of a comparable gas turbine plant 16 with a mostly closed CO₂ gas turbine circuit. The gas turbine plant 16 comprises a compressor 1 and a turbine 3 which are connected to a generator 15 via a common shaft. The gas turbine plant 16 comprises, furthermore, a combustion chamber 2, a cooler and/or waste heat recuperator 4, a water separator 5 and a tapping point 6 for the tapping of CO₂. In the combustion chamber 2, a fuel 7 in the form of a hydrocarbon, for example a natural gas with methane as the main component, is subjected to an internal combustion in an atmosphere prepared from oxygen 8, carbon dioxide and, if appropriate, water. The components occurring as a result of combustion, to be precise carbon dioxide and water, and also, if appropriate, inert gases introduced together with the oxygen or with the natural gas, are removed continuously, so that a circuit with a largely constant composition of the working medium is maintained. In this case, as illustrated in FIG. 1. the water can be condensed out in the water separator 5. At another point in the Circuit, preferably downstream of the compressor 1 at the tapping point 6, the excess carbon dioxide can be separated in a largely pure state. The carbon dioxide can then be dumped in a suitable way, so that virtually no carbon dioxide is discharged into the atmosphere. Alternatively, no water or only part of the water may be condensed out in the water separator 5, so that a carbon dioxide/water mixture is discharged at the tapping point 6.

The oxygen 8 required for the combustion of the fuel 7 is generated from sucked-in air 10 in an air separation unit 9. Residual gases 11 in the form of nitrogen (N₂) and argon (Ar), which in this case occur as a waste product, can either be released into the atmosphere or utilized in another way.

The steam 17 generated in the cooler/waste heat recuperator 4 can either be utilized in an independent process, for example in a downstream steam turbine, or can be injected as injection steam 12 into the combustion chamber 2, in order to increase the mass flow in the turbine 3 and consequently the power output and efficiency of the process. In addition, a part stream 13 of the steam may be utilized for the effective cooling of components in the turbine 3 which are subjected to thermal load.

If the compressor 1 and the turbine 3 are designed and constructed especially for the requirements of the respective working medium, there is no doubt as to the technical feasibility of such a process. However, it will become necessary, for economic reasons, to operate corresponding gas turbine plants 16 at least temporarily with compressors 1 and turbines 3 that have been modified as little as possible on the basis of existing machines designed for operating with ambient air.

In this respect, the speed of sound in carbon dioxide, which is very much lower as compared with air, is discussed in the literature as the most important challenge. However, FIG. 2, in which the speed of sound in carbon dioxide/water mixtures is plotted as a function of the fraction of water in the case of a pressure of 3 MPa at two different temperatures (700 K and 1400 K), shows that, using carbon dioxide/water mixtures, it is possible, over wide concentration ranges (for example, 0.6<X_{H2O}<0.8), to set speeds of sound which are sufficiently similar to the speed of sound in air (if it is assumed that compressors of large gas turbines are typically operated with Mach numbers of about 0.7, then speeds of sound up to about 20% lower should be acceptable).

By contrast, a considerable problem arises due to the different expansion and compression behavior of air, on the one hand, and of carbon dioxide/water mixtures, on the other hand. FIG. 3, in which the deviation of the volume flow is represented in % during the expansion of carbon dioxide/water mixtures, as compared with air, for three different water fractions x, illustrates this relation by the example of an expansion starting from T=1500 K and p=3 MPa and having a polytropic efficiency of ηₚₒₗ=0.9 which is assumed to be constant. Since the isentropic exponent of carbon dioxide/water mixtures is different from that of air, this results in volume flows which are approximately 30 to 35% greater on the low-pressure side and consequently, with flow cross sections being unchanged, in correspondingly higher axial speeds. This effect can be influenced only to a slight extent by a variation in the composition. Conversely, in the compressor 1, markedly smaller volume flows and consequently lower axial speeds are obtained on the high-pressure side than in operation with air.

A further difficulty is that noncondensable inert gases accumulate in the circuit, of which the concentration in equilibrium is approximately equal to the fraction of the corresponding gases in the natural gas used. This results, depending on the natural gas used, in sufficiently different thermodynamic properties of the working medium.

The outlay in terms of the modification of existing turbines and consequently their chances of success depend essentially on whether it is possible to compensate these differences in the expansion behavior, without the rotors and casings of the turbines having to be drastically modified and the blading having to be completely redesigned.

### SUMMARY OF THE INVENTION

The present invention, therefore, provides a gas turbine plant that operates with a carbon dioxide/water mixture as working medium and makes use, in a simple and cost-effective way, of a compressor and/or a turbine that are designed for operating with air as the working medium.

In essence, the invention uses a compressor and/or turbine (3) with a rotor and a casing that correspond largely to a rotor and a casing of a compressor designed for air as the working medium or of a turbine designed for air as the working medium. Matching to the expansion behavior of the working medium which is different from that of air is then brought about essentially by modifications of the flow ducts and/or of the moving blades and/or of the guide blade cascade. It is thereby possible to build on already existing compressors or turbines which are then matched internally to the new working medium by means of comparatively insignificant changes.

According to a first refinement of the invention, the necessary modification is brought about in that the free flow cross sections on the high-pressure side of the compressor and/or turbine are reduced by the blocking of part of the flow ducts in the guide blade cascade in the form of blocked sectors.

According to a second preferred refinement of the invention, the necessary modification is brought about in that the free flow cross sections on the high-pressure side of the compressor and/or turbine are reduced by the insertion of annular flow obstacles in the guide blade cascades.

According to a third preferred refinement of the invention, the necessary modification is brought about in that the free flow cross sections on the high-pressure side of the compressor and/or turbine are reduced by means of adjustable guide blade cascades.

It is also conceivable, however, that the free flow cross sections in the compressor and/or turbine remain unchanged and, instead, the blading of the compressor or of the turbine is matched to the changed axial speeds.

It is advantageous, furthermore, if adjustable guide blade cascades are provided in the compressor and/or turbine, in order to compensate variations in the thermodynamic properties of the working medium, said variations being caused by inert gases.

### BRIEF DESCRIPTION OF THE DRAWINGS

The invention will be explained in more detail below with reference to exemplary embodiments, in conjunction with the drawing in which:

FIG. 1 shows a plant diagram of an exemplary gas turbine plant operating with a carbon dioxide/water mixture as working medium;

FIG. 2 shows the speed of sound in carbon dioxide/water mixtures as a function of the fraction of water in the case of a pressure of 3 MPa at two different temperatures;

FIG. 3 shows the deviation of the volume flow in % during the expansion of carbon dioxide/water mixtures, as compared with air, for three different water fractions;

FIG. 4 shows percentage deviations between axial speeds that are established in a turbine optimized for air and axial speeds in a 5-stage turbine operated with various carbon dioxide/water mixtures and modified according to the invention;

FIG. 5 shows a diagrammatic illustration of the internal construction of a compressor or of a turbine with the associated blading and with a plurality of guide blade cascades; and

FIG. 6 shows in several part figures, as seen in the axial direction, an exemplary guide blade cascade without modification (FIG. 6a), with sectorial partial action according to one refinement of the invention (FIG. 6b), with radial partial action according to another refinement of the invention (FIG. 6c) and with adjustable guide blades according to a further refinement of the invention (FIG. 6d).

### DETAILED DESCRIPTION OF THE PREFERRED EMBODIMENTS

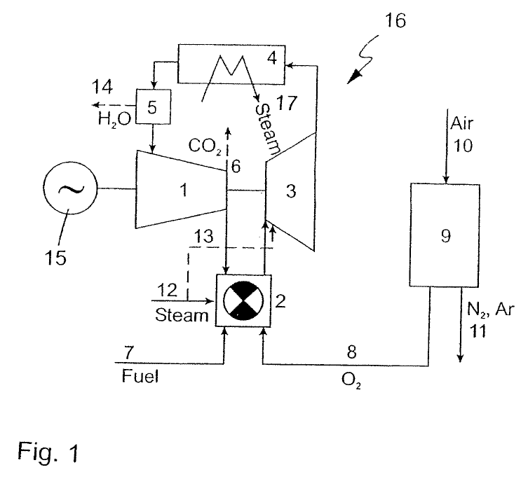

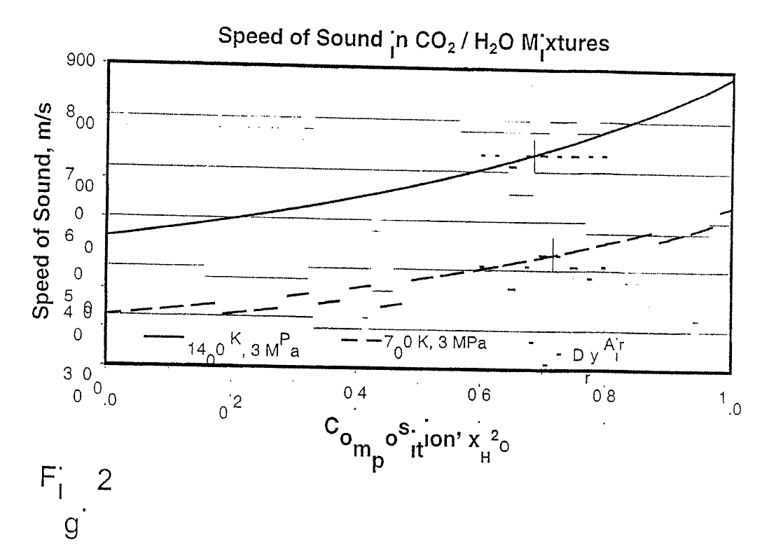

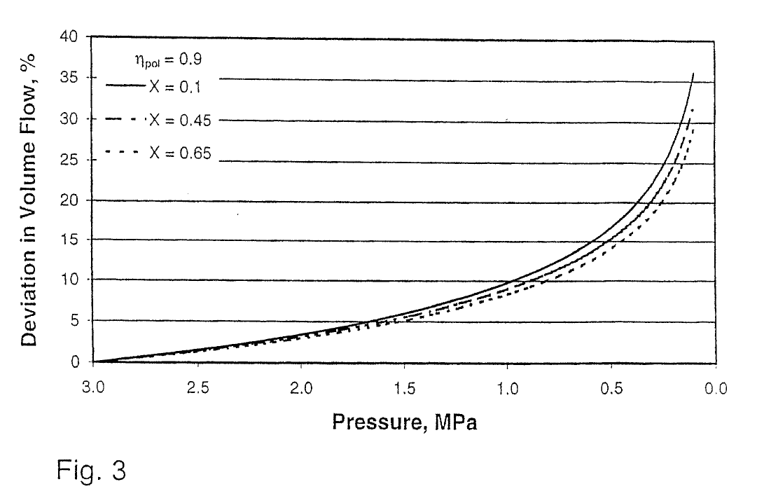

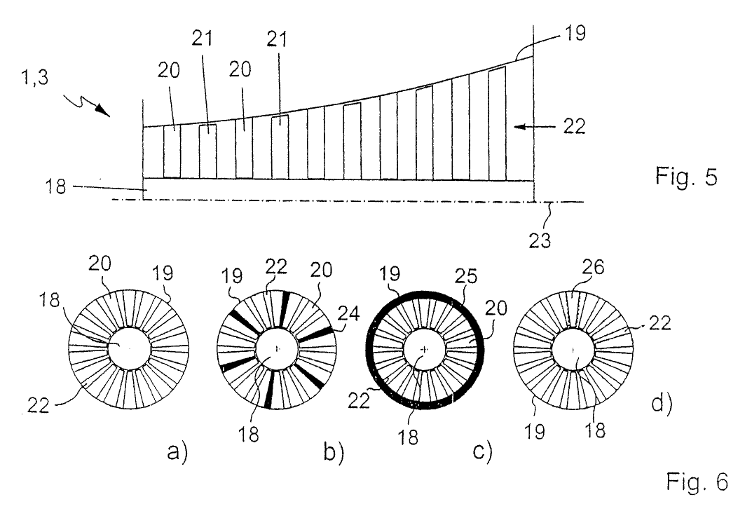

The compressor 1 and the turbine 3 of the gas turbine plant from FIG. 1 have the internal construction illustrated in simplified form in FIG. 5, the high-pressure side (the outlet side in the case of the compressor 1 and the inlet side in the case of the turbine 3) being located on the left side of the illustration. The compressor 1 and the turbine 3 have a rotor 18 rotatable about an axis 23 and having a multistage blading which consists of individual sets of moving blades 21. The rotor 18 with the blading is surrounded by a casing 19. Between the sets of moving blades 21 are arranged in each case fixed guide blade cascades 20 with corresponding guide blades. Flow ducts 22 run between the guide blades of the guide blade cascades 20 in the interspace of the rotor 18 and casing 19 (see also FIG. 6a).

According to the invention, then, the rotor 18 and casing 19 of a compressor 1 designed for air as the working medium and/or of a turbine 3 designed for air as the working medium are preserved. For matching to the expansion behavior of carbon dioxide/water as working medium, said expansion behavior being different from that of air, essentially modifications of the flow ducts 22 and/or of the guide blades 21 and/or of the guide blade cascades 20 are carried out.

A first possibility for modification involves reducing the free flow cross sections on the high-pressure side of the compressor 1 and/or turbine 3 in that some of the flow ducts 22 in the associated guide blade cascade 20 are closed by means of blocked sectors 24 arranged so as to be distributed over the circumference (FIG. 6b; sectorial partial action).

A second possibility for modification involves reducing the free flow cross sections on the high-pressure side of the compressor 1 and/or turbine 3 by the insertion of annular flow obstacles 25 in the guide blade cascades 20 (FIG. 6c; radial partial action).

A third possibility for modification involves reducing the free flow cross sections on the high-pressure side of the compressor 1 and/or turbine 3 by means of adjustable guide blade cascades 20 with adjustable guide blades 26 (FIG. 6d; only one exemplary adjustable guide blade 26, the adjustability of which is indicated by the broken lines, is depicted in the figure for the sake of simplicity).

It is also conceivable, however, that the free flow cross sections in the compressor 1 and/or turbine 3 remain unchanged, and, instead, the blading (moving blades 21) of the compressor 1 or of the turbine 3 is matched to the changed axial speeds by means of a changed configuration of the blade geometry.

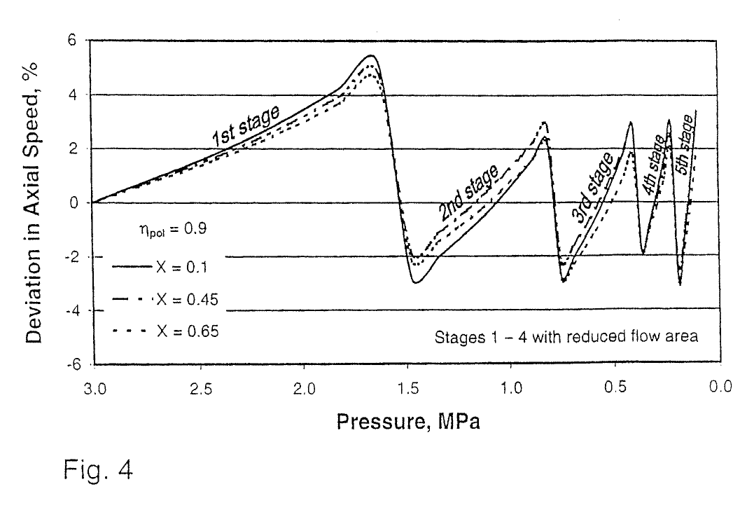

FIG. 4 shows, by the example of a five-stage turbine, percentage deviations between axial speeds which occur in a turbine optimized for air and axial speeds in turbines operated with various carbon dioxide/water mixtures and modified according to the invention. The substantial assimilation of the axial speeds is achieved, in this case, by means of a graded reduction of the available flow cross sections in the individual stages of the turbine. The following Table 1 collates the cross-sectional ratios selected for the various compositions.

TABLE 1
Related ratio of the free flow cross sections in the stages of
turbines modified for operation with carbon dioxide/water mixtures

| | | | Related flow cross sections | | |
|---|---|---|---|---|---|
| Composition | | | A_{CO2/H2O}/Aₐᵢᵣ | | |
| | 1^{st} Stage | 2^{nd} Stage | 3^{rd} Stage | 4^{th} Stage | 5^{th} Stage |
| X_{H2O} = 0.10 | 0.76 | 0.83 | 0.88 | 0.93 | 1 |
| X_{H2O} = 0.45 | 0.78 | 0.84 | 0.89 | 0.94 | 1 |
| X_{H2O} = 0.65 | 0.79 | 0.85 | 0.90 | 0.94 | 1 |

When inert gases occur in the working medium, it is advantageous, furthermore, if adjustable guide blades 26 of the guide blade cascade 20 are provided in the compressor 1 and/or turbine 3, in order to compensate variations in the thermodynamic properties of the working medium, said variations being caused by the inert gases.

It may also be advantageous, in the gas turbine plant 16 of the invention, if the heat sink 4 is designed for the generation of steam, and if a part stream 13 of the generated steam is supplied for the cooling of components of the turbine 3 which are subjected to thermal load. This heat sink 4 may also be designed for generating a steam quantity for operating a steam turbine, not illustrated in any more detail in the drawing. The required part stream 13 can then be branched off from this steam quantity.

Finally, however, it is also possible that means for condensing the working medium by the discharge of heat are provided in the gas turbine plant 16 from FIG. 1, and that a pump is used instead of the compressor 1.

What is claimed is:

1-20. (canceled)

21. A method for converting a gas turbine plant, which has been designed for an operation with air as a working medium, to operate with a carbon dioxide/water mixture as a working medium, said method comprising the steps of:
providing a gas turbine plant including a compressor, a combustion chamber, a turbine and at least one heat sink, said gas turbine plant being designed for an operation with air as a working medium;
wherein the compressor and the turbine each have a rotor and a casing surrounding the rotor thereby defining annular flow ducts for the working medium;
wherein running blades are arranged on the rotor, and guiding vanes are arranged in the flow ducts; and
adapting in at least one of the compressor and the turbine the flow ducts to accommodate the different expansion behavior of the carbon dioxide/water mixture as the working medium.

22. The method as claimed in claim 21, wherein the flow ducts are adapted by reducing free flow cross-sections thereof on a high-pressure side of at least one selected from the group consisting of the compressor and the turbine.

23. The method as claimed in claim 22, wherein the free flow cross-sections of the flow ducts are reduced by blocking some sectors between neighboring guiding vanes.

24. The method as claimed in claim 22, wherein the free flow cross-sections of the flow ducts are reduced by inserting annular flow obstacles into said flow ducts.

25. The method as claimed in claim 22, wherein the free flow cross-sections of the flow ducts are reduced by providing adjustable guiding vanes and adjusting said guiding vanes.

26. The method as claimed in claim 21, wherein:
means are provided for condensing the working medium by discharging heat; and
the compressor is replaced by a pump.

27. A method for converting a gas turbine plant, which has been designed for an operation with air as a working medium, to operate with a carbon dioxide/water mixture as a working medium, said method comprising the steps of:
providing a gas turbine plant including a compressor, a combustion chamber, a turbine and at least one heat sink, said gas turbine plant being designed for an operation with air as a working medium;
wherein the compressor and the turbine each have a rotor and a casing surrounding the rotor thereby defining annular flow ducts for the working medium;
wherein running blades are arranged on the rotor, and guiding vanes are arranged in the flow ducts; and
adapting in at least one of the compressor and the turbine the running blades to accommodate a different axial velocity of the carbon dioxide/water mixture as the working medium.
